(19) United States
(12) Patent Application Publication
(10) Pub. No.: US 2025/0344907 A1
(43) Pub. Date: Nov. 13, 2025

(54) STAND MIXER ATTACHMENT BIASING COMBINATION

(71) Applicant: Zachary David Dinicola, Augusta, KS (US)

(72) Inventor: Zachary David Dinicola, Augusta, KS (US)

(21) Appl. No.: 19/201,393

(22) Filed: May 7, 2025

Related U.S. Application Data
(60) Provisional application No. 63/731,476, filed on May 7, 2024.

(51) Int. Cl. A47J 43/07; A47J 43/044

(52) U.S. Cl. CPC A47J 43/0711; A47J 43/044; A47J 2043/04454

(57) ABSTRACT

A mixer attachment biasing combination is disclosed herein. The mixer attachment biasing combination may comprise a spring and a split washer. The mixer attachment biasing combination may be installed onto an existing stand mixer shaft without requiring any disassembly of the stand mixer. Once installed, the mixer attachment biasing combination may supply a distally-directed force against a mixer attachment, preventing movement of the attachment along the shaft.

### CROSS-REFERENCE TO RELATED APPLICATIONS

The present patent application claims priority to the United States provisional patent application identified by U.S. Ser. No. 63/731,476 filed on May 7, 2024, the entire content of which is hereby incorporated herein by reference.

### BACKGROUND

Stand mixers, ubiquitous in both home and professional kitchens, are essential tools for a wide range of food preparation tasks. These appliances typically employ a powered rotating shaft to drive various attachments, such as beaters, paddles, dough hooks, and whisks, within a mixing bowl. The interaction between these attachments and the ingredients within the bowl is crucial for achieving desired mixing results.

Traditional stand mixer attachment systems often rely on a simple mechanical connection between the attachment and the drive shaft. Over time, wear and tear can introduce play or looseness between the attachment and the shaft. This looseness eventually allows the attachment to move vertically along the shaft during operation, causing inconsistencies in mixing. Further, because the shaft is typically stainless steel and the attachments are typically made of a softer metal such as burnished aluminum, movement along the shaft causes wear on the inner diameter of the attachment hub. This wear results in even more looseness, increasing the looseness of the hub.

Historically, some stand mixer designs incorporated a spring and washer to counteract these issues. However, recent manufacturing trends have seen the removal of this spring and washer from many stand mixer models. This omission has resulted in a resurgence of the aforementioned operational challenges, leaving consumers seeking solutions to restore the original functionality and longevity of their appliances. Specifically, the vertical movement of the attachment can result in uneven mixing, where ingredients at the bottom of the bowl are not adequately incorporated, attachment wear, potential damage to the planetary gear system from excess play, and unwanted noise and vibration during operation.

Furthermore, the advent of newer stand mixer models, featuring design changes such as press-fit gears, has rendered traditional installation methods for such spring and washer combinations difficult or impossible. Contemporary attempts to retrofit traditional springs and washers into some modern mixers requires significant effort, often involving disassembly of the motor housing and removal of the rotating shaft. In other modern mixers, non-removable press-fit gears make retrofitting a traditional spring and washer unfeasible.

### SUMMARY

Therefore, need for an improved system that effectively addresses the shortcomings of existing designs, providing a robust and easily installable solution for both older and newer stand mixer models. Such an improvement should effectively minimize attachment play, enhance mixing performance, and extend the lifespan of stand mixer components. The present disclosure addresses these issues through a novel stand mixer attachment biasing combination, comprising a custom-fit spring and split washer for installation without requiring disassembly of the stand mixer.

A stand mixer assembly having a novel stand mixer attachment biasing combination is disclosed herein. In general, in a first aspect, a stand mixer assembly may comprise a motor housing, a motor disposed within the motor housing, a shaft operably connected to the motor so the shaft is rotatable and having a portion extending from the motor housing, and a retaining pin extending laterally from the shaft. The stand mixer assembly may further have a mixer attachment biasing combination, which may be a compression spring and a split washer. The compression spring may have an upper end and a lower end and disposed about the shaft and positioned between the motor housing and the retaining pin. The split washer may be positioned about the shaft between the lower end of the compression spring and the retaining pin so the compression spring biases the split washer toward the retaining pin. The split washer may further have an external rim and an opening defined by an internal rim. The split washer may further have a gap defined by a first end and a second end of the split washer, so the first end and the second end are movable relative to one another.

In some implementations, the split washer and compression spring may comprise stainless steel. In some implementations, the gap may be a straight-line cut or a curved-line cut in the split washer. The gap 350 may have a width of between about 0.001 inches to 0.25 inches or between about 0.01 and 0.1 inches, or preferably about 0.01 inches. In some implementations, the gap 350 may be sized such that at least a portion of the first end and the second end are touching. In some implementations, the washer may have a thickness of about 0.034 inches (or in some embodiments about 0.0335 inches), an inner diameter of about 0.5 inches (or in some embodiments about 0.503 inches), and an outer diameter of about 0.75 inches.

A method for securing a mixer attachment having a hub with a notch to a shaft of a standing mixer extending from a motor housing, the shaft having a retaining pin with a diameter and extending laterally from the shaft, may comprise obtaining a compression spring having an upper end and a lower end and positioning the compression spring on the shaft. The compression spring may be threaded past the retaining pin so the compression spring is positioned between the motor housing and the retaining pin. A split washer having an external rim and an opening defined by an internal rim and having a gap defined by a first end and a second end of the split washer may be provided. The split washer may be resilient in a way that the first end and the second end are axially movable relative to one another. By axially moving the first end of the split washer and the second end of the split washer away from one another so that the first end and the second end are spaced a distance equal to at least the diameter of the retaining pin, the split washer may be slid along the shaft past the retaining pin so the washer is positioned between the lower end of the compression spring and the retaining pin. The compression spring may bias the washer toward the retaining pin. The hub of the mixer attachment may be inserted onto the shaft so the notch receives the retaining pin and the washer circumferentially engages the hub. The mixer attachment may be rotated to misalign the retaining pin and the notch so the mixer attachment is connected to the shaft and the washer biases the hub of the mixer attachment against the retaining pin.

The foregoing summary provides an overview of certain selected implementations or embodiments disclosed herein, and is not intended to describe every aspect, embodiment, implementation, feature, or advantage of the disclosure exhaustively or comprehensively. Therefore, this summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

The details of one or more implementations of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1A is an illustration of a stand mixer head assembly with an exemplary embodiment of a mixer attachment biasing combination installed in accordance with the present disclosure.

FIG. 1B is an illustration of an exemplary embodiment of a shaft of a stand mixer head assembly without a mixer attachment biasing assembly installed.

FIG. 1C is an illustration of the stand mixer head assembly of FIG. 1A with the mixer attachment biasing combination and a mixer attachment installed.

FIG. 1D is an illustration of a top-down view of an exemplary embodiment of the hub constructed in accordance with the present disclosure.

FIG. 2A is a side view of an exemplary embodiment of a spring component of a mixer attachment biasing combination constructed in accordance with the present disclosure.

FIG. 2B is a top view of an exemplary embodiment of the spring component of the mixer attachment biasing combination constructed in accordance with the present disclosure.

FIG. 2C is an illustration of an exemplary embodiment of a wire segment of the spring component of the mixer attachment biasing combination constructed in accordance with the present disclosure.

FIG. 3A is a top view of an exemplary embodiment of a split washer component of the mixer attachment biasing combination constructed in accordance with the present disclosure.

FIG. 3B is a side view of an exemplary embodiment of the split washer component of the mixer attachment biasing combination constructed in accordance with the present disclosure.

FIG. 3C is a top view of an exemplary embodiment of the split washer component of the mixer attachment biasing combination showing a first gap constructed in accordance with the present disclosure.

FIG. 3D is a top view of an exemplary embodiment of the split washer component of the mixer attachment biasing combination showing a second gap constructed in accordance with the present disclosure.

FIG. 3E is a top view of an exemplary embodiment of the split washer component of the mixer attachment biasing combination showing a third gap constructed in accordance with the present disclosure.

FIG. 3F is a side view of an exemplary embodiment of the split washer component of the mixer attachment biasing combination showing a first open position in accordance with the present disclosure.

FIG. 3G is a side view of an exemplary embodiment of the split washer component of the mixer attachment biasing combination showing a second open position in accordance with the present disclosure.

FIG. 4 is a first perspective view of an exemplary embodiment of the mixer attachment biasing combination constructed in accordance with the present disclosure.

FIG. 5A illustrates an exemplary embodiment of a first step of installing the mixer attachment biasing assembly to the stand mixer shaft in accordance with the present disclosure.

FIG. 5B illustrates an exemplary embodiment of a second step of installing the mixer attachment biasing assembly to the stand mixer shaft in accordance with the present disclosure.

FIG. 5C illustrates an exemplary embodiment of a third step of installing the mixer attachment biasing assembly to the stand mixer shaft in accordance with the present disclosure.

FIG. 5D illustrates an exemplary embodiment of a fourth step of installing the mixer attachment biasing assembly to the stand mixer shaft in accordance with the present disclosure.

FIG. 5E illustrates an exemplary embodiment of a fifth step of installing the mixer attachment biasing assembly to the stand mixer shaft in accordance with the present disclosure.

FIG. 6 is an exemplary flow diagram of a method of installing the mixer attachment biasing assembly in accordance with the present disclosure.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example. In some embodiments, the term “about” may refer to a range of values within 5% of the specified value.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, all numerical values or ranges include fractions of the values and integers within such ranges and fractions of the integers within such ranges unless the context clearly indicates otherwise. Reference to a series of ranges includes ranges which combine the values of the boundaries of different ranges within the series. Any two values within the ranges, therefore, can be used to set a lower and an upper boundary of a range in accordance with the embodiments of the present disclosure.

Finally, as used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

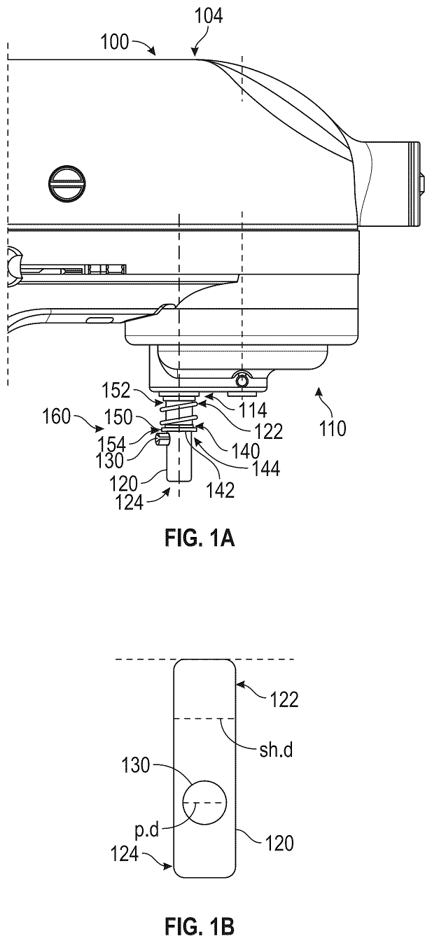

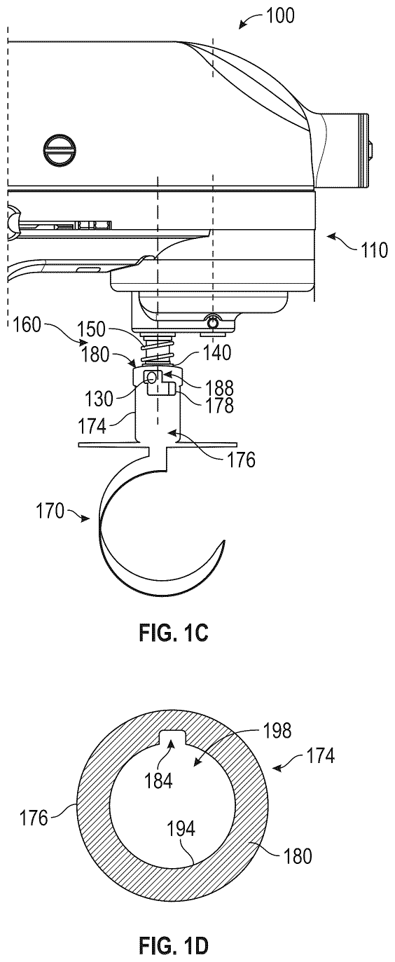

Referring now to the drawings, and in particular to FIG. 1A, shown therein is an illustration of an exemplary embodiment of head assembly 100 of a stand mixer 104 without a mixer attachment 170 (shown in FIG. 1B) installed according to the present disclosure. The head assembly 100 may comprise a motor housing 110 having an outer surface 114 and constructed to support and house a motor (not shown), electronics (not shown), a gear assembly (not shown), and other components of the stand mixer 104. A shaft 120 having a proximal end 122 and a distal end 124 opposite the proximal end 122 may extend axially from the motor housing 110 and be coupled to the gear assembly and motor. Thus, the shaft 120 may be rotatable upon activation of the motor. A retaining pin 130 may extend radially from the shaft 120. An attachment biasing combination 160 may be disposed between the motor housing 110 and the retaining pin 130. Exemplary implementations of a stand mixer 104 without the attachment biasing combination 160 may include, for example, a KitchenAid K50 (Whirlpool Corporation, Benton Harbor, MI).

As shown in FIG. 1A, the attachment biasing combination 160 may comprise a split washer 140 having an upper surface 142 and a lower surface 144 and a spring 150 having an upper end 152 and a lower end 154. The spring 150 and split washer 140 may be disposed circumferentially about the shaft 120 such that the upper end 152 of the spring 150 may engage the outer surface 114 of the motor housing 110, while the lower end 154 of the spring 150 may engage the upper surface 142 of the split washer 140. The lower surface 144 of the split washer 140 may engage the retaining pin 130.

The number of devices and/or components illustrated in FIG. 1A is provided for explanatory purposes. In practice, there may be additional devices and/or components, fewer devices and/or components, different devices and/or components, or differently arranged devices and/or components than are shown in FIG. 1A. Furthermore, two or more of the components illustrated in FIG. 1A may be implemented within single components, or single components illustrated in FIG. 1A may be implemented as multiple, distinct components. The number of components of the stand mixer 104 is shown for simplicity.

Turning to FIG. 1B, shown therein is an exemplary embodiment of the shaft 120 without the attachment biasing combination 160. The shaft 120 may be cylindrical and have a diameter sh.d. The retaining pin 130 may be cylindrical and have a longitudinal axis perpendicular to the shaft 120. The retaining pin 130 may have a diameter p.d.

Turning to FIG. 1C, shown therein is an exemplary embodiment of the head assembly 100 of FIG. 1A further including the mixer attachment 170 attached to the stand mixer 104. The mixer attachment 170 may have a hub 174 having a hub outer surface 176, a groove 178 disposed in the hub 174, a hub top surface 180, and a notch 184 disposed within the hub top surface 180. The hub 174 may slide over the distal end 124 of the shaft 120 and over the retaining pin 130 such that the notch 184 receives the retaining pin 130. The hub 174 may then be rotated such that the groove 178 engages the retaining pin 130, thereby holding the mixer attachment 170 on the shaft 120.

In one embodiment, the hub 174 may be at least partially disposed between the split washer 140 and the retaining pin 130. Therefore, the split washer 140 no longer engages the retaining pin 130 and instead engages the hub top surface 180 of the hub 174. In other words, attaching the mixer attachment 170 displaces the split washer 140 away from the retaining pin 130. Because the split washer 140 engages the spring 150, which engages the motor housing 110, displacement of the split washer 140 away from the retaining pin 130 compresses the spring 150. The compressed spring 150 thus applies a restoring force to the hub top surface 180 of the hub 174 through the split washer 140, thereby applying a distally-directed force against the retaining pin 130 held in the groove 178. This restoring force of the spring 150 thus biases the retaining pin 130 into a locked position 188 in the groove 178 and biases the mixer attachment 170 firmly towards the distal end 124 of the shaft 120.

Turning to FIG. 1D, shown therein is an illustration of a top-down view of an exemplary embodiment of the hub 174. The hub 174 may have a hub inner surface 194. The hub inner surface 194 may define a hub aperture 198 which may receive the shaft 120. The hub inner surface 194 may further define the notch 184 disposed in the hub top surface 180 and the hub inner surface 194 of the hub 174 to receive the retaining pin 130. The notch 184 may be contiguous with the hub aperture 198 such that the shaft 120 and the retaining pin 130 may be inserted into the notch 184 and hub aperture 198.

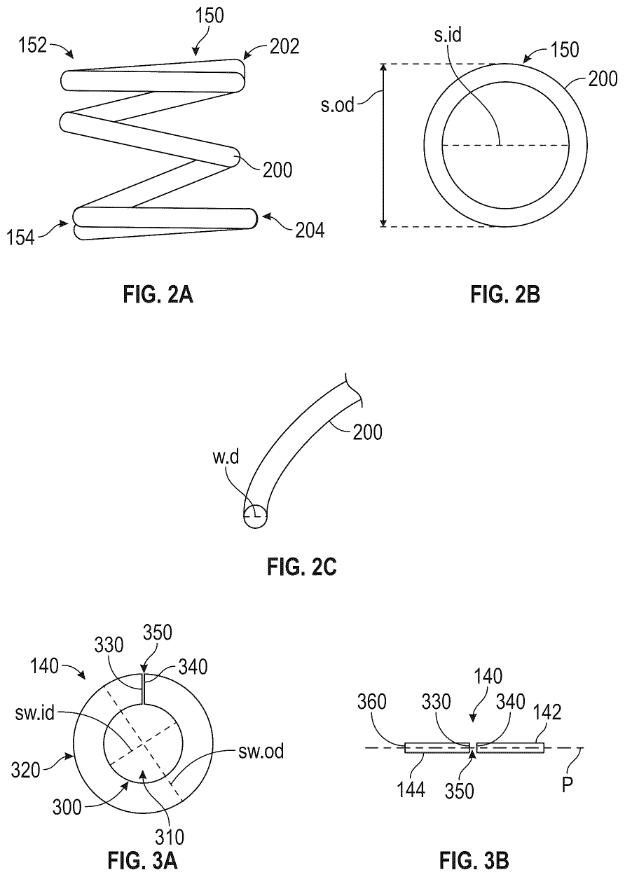

Turning to FIGS. 2A-2C, shown therein are illustrations of an exemplary embodiment of the spring 150 constructed in accordance with the present disclosure. The spring 150 may have an upper end 152 and a lower end 154. The upper end 152 may engage outer surface 114 of the motor housing 110, while the lower end 154 may engage the split washer 140.

The spring 150 may comprise a wire 200 having a wire upper end 202 at the upper end 152 of the spring 150 and a wire lower end 204 at the lower end 154 of the spring 150. The spring 150 may have an inner diameter s.id and an outer diameter s.od. The inner diameter s.id may be any size configured to securely adhere to the shaft 120. In some implementations, the inner diameter s.id may be within 5% of the outer diameter s.od of the shaft 120. In some implementations, the inner diameter s.id may be in a range between 0.4 inches and 0.6 inches, more preferably between 0.45 inches and 0.55 inches, more preferably between 0.5 inches and 0.54 inches, and most preferably 0.52 inches.

The wire 200 may be comprised of any durable, resilient material safe for the handling of food. In some implementations, the wire 200 may be a rust-resistant metal including, but not limited to: stainless steels such as types 302, 304, 316, and 17-7 PH; nickel alloys like Inconel X-750 and Elgiloy; and copper alloys including phosphor bronze and beryllium copper. Preferably, the wire may comprise stainless steel 302 A313. In some implementations, the wire 200 may be a durable plastic material including, but not limited to: acetal, polycarbonate (PC), polyamide, Nylon, polypropylene, thermoplastic polyurethane (TPU), and strong fiber-reinforced plastic. In some implementations, the wire 200 may be a metal coated with a material such as a rubber or elastomer such as natural rubber, Styrene-Butadiene Rubber, Nitrile Rubber, Neoprene, Silicone rubber, Polyurethane, thermoplastic elastomers such as SEBS, and Ethylene Propylene Diene Monomer.

The wire 200 may have a wire diameter w.d and number of coils appropriate to achieve a desired spring rate k of the spring 150, calculated according to the following formula:

$$k = \frac{G * {( w \cdot d )}^{4}}{8 N * {D}^{3}} ,$$

where G is the shear modulus of the spring material, w.d is the wire diameter, D is the mean coil diameter (s.id), and N is the number of active coils.

In some implementations, it may be desired that the spring 150 have a k value in a range of 20 lbs/inch to 25 lbs/inch, more preferably 21 lbs/inch to 23 lbs/inch, more preferably 22.5 lbs/inch to 22.8 lbs/inch, more preferably 22.6 lbs/inch, and most preferably 22.621 lbs/inch. In some implementations, the spring 150 may have a true maximum load, which represents the theoretical limit before permanent deformation, in a range of 6 lbsF to 9 lbsF, more preferably 7 lbsF to 8 lbsF, and most preferably about 7.269 lbsF. The maximum load considering the solid height of the spring may be in a range of 6 lbsF to 9 lbsF, more preferably 7 lbsF to 8 lbsF, and most preferably about 7.269 lbsF.

In some implementations, the spring 150 may be designed to have a potential true maximum travel in a range of 0.2 inches to 0.5 inches, more preferably 0.28 inches to 0.4 inches, and most preferably about 0.321 inches. The maximum travel considering the solid height, which is the difference between the free length and the solid height, may be in a range of 0.3 inches to 0.5 inches, more preferably 0.35 inches to 0.4 inches, and most preferably about 0.374 inches based on the provided free length and solid height, although a safe operating travel may be considered to be about 0.321 inches. In some embodiments, the maximum travel considering the solid height may be about 0.321 inches, e.g., the same as the save operating travel distance.

Furthermore, the spring 150 may have a minimum loaded height, representing the shortest recommended operating height under load, in a range of 0.2 inches to 0.3 inches, more preferably 0.22 inches to 0.26 inches, and most preferably about 0.244 inches.

In some implementations, the wire may have the wire diameter w.d in a range of 0.3 inches to 0.5 inches, more preferably 0.38 inched to 0.48 inches, more preferably 0.36 inches to 0.46 inches, and most preferably 0.45 inches. In some implementations, the wire 200 may have a length of 4 inches to 7 inches, more preferably 5 inches to 6 inches, and most preferably about 5.7 inches. The solid height of the spring 150 may be in a range of 0.15 inches to 0.25 inches, more preferably 0.18 inches to 0.2 inches, and most preferably about 0.191 inches. The ends of the wire 200 may be of a closed and squared type. The spring index, which is the ratio of the mean diameter to the wire diameter, may be in a range of 10 to 15, and most preferably about 12.556.

In some implementations, the wire may have a number N of active coils in a range of 1 to 2 coils, and most preferably 1.25 coils. A total number of coils may be in a range of 2 to 5 coils, and more preferable 3 to 4 coils, and most preferable 3.25 coils. In some implementations, the spring 150 may have a distance between coils (“coil pitch”) of between 0.3 inches and 0.4 inches, preferably between 0.32 inches and 0.36 inches, more preferably between 0.34 inches and 0.35 inches, and most preferably about 0.344 inches. The coils may have a rise angle in a range of 10 degrees to 12 degrees, and preferably about 10.97 degrees.

The shear modulus G may vary depending upon the material used. For example, the material shear modulus G for stainless steel 302 A313 may be about 9,949,476 psi. The maximum shear stress possible for the material may be in a range of 120,000 psi to 130,000 psi, and most preferably about 127,840.000 psi. The Wahl correction factor W, accounting for stress concentration due to curvature, may be in a range of 1.1 to 1.2, and most preferably about 1.114.

The spring 150 may have the outer diameter s.od which may securely engage the motor housing 110 at the upper end 202 and the split washer 140 at the lower end 204. The outer diameter s.od may also be a sum of a desired inner diameter s.id and a desired wire diameter w.d. In some implementations, the spring outer diameter s.od may be in a range between 0.5 inches and 0.7 inches, more preferably between 0.55 inches and 0.65 inches more preferably between 0.59 inches and 0.62 inches, and most preferably 0.61 inches.

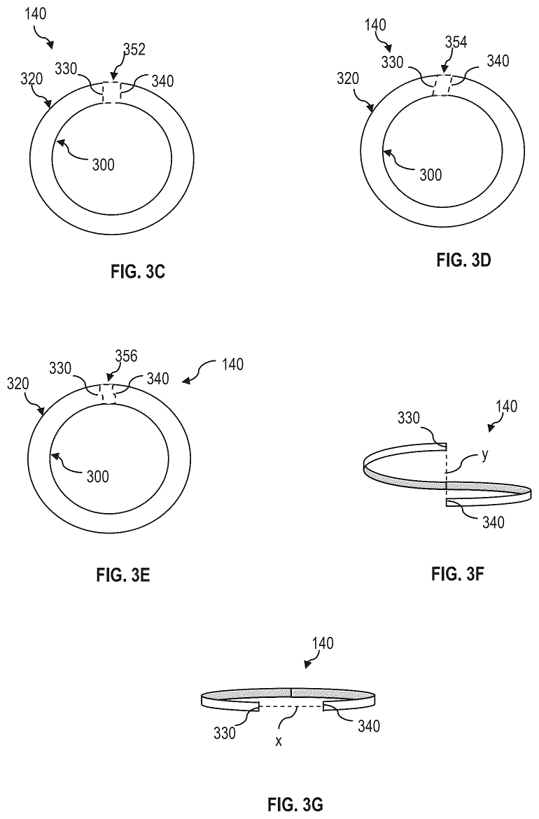

Turning to FIGS. 3A-3G, in combination, shown therein are illustrations of an exemplary embodiment of the split washer 140 constructed in accordance with the present disclosure. The split washer 140 may generally take any suitable form, such as a plain washer, a square washer, a wave washer, a conical spring washer, and a star washer. The split washer 140 may have an internal rim 300 defining an aperture 310 and an external rim 320. The split washer may have a first end 330 and a second end 340 which adjoin the internal rim 300 and the external rim 320. The first end 330 and the second end 340 may define a gap 350. The split washer 140 may further have the upper surface 142 and the lower surface 144. The upper surface 142 may engage the lower end 154 of the spring 150, and the lower surface 144 may engage the retaining pin 130 or, if a mixer attachment 170 is attached to the shaft 120, the hub top surface 180. The split washer 140 may further have a lateral surface 360.

The split washer 140 may have an inner diameter sw.id configured to securely engage the shaft 120, such as within 5% of the outer diameter of the shaft 120. The inner diameter sw.id of the split washer 140 may also be configured to prevent intrusion of the wire 200 of spring 150 between the split washer 140 and the shaft 120. Thus, in some implementations, the inner diameter sw.id of the split washer 140 may be smaller than the inner diameter s.id of the spring 150. The inner diameter sw.id of the split washer 140 may be in a range between 0.4 inches and 0.6 inches, more preferably between 0.45 inches and 0.55 inches, more preferably between 0.49 inches and 0.52 inches, more preferably about 0.5 inches, and most preferably 0.503 inches.

The split washer 140 may further have an outer diameter sw.od configured to provide a sufficient surface area on the upper surface 142 and lower surface 144 for transfer of spring 150 restoring force to the hub top surface 180. In some implementations, the split washer 140 may have an outer diameter sw.od in a range between 0.6 inches to 0.9 inches, more preferably between 0.7 inches to 0.8 inches, more preferably between 0.74 inches and 0.76 inches, and most preferably 0.75 inches.

The split washer 140 may further have a thickness measured as a distance between the upper surface 142 and the lower surface 144. The thickness may be sufficient to maintain the resilience of the split washer 140 while being thin enough to allow for ease of opening. In some implementations, the thickness may be in a range between 0.025 inches and 0.045 inches, more preferably between 0.28 inches and 0.38 inches, more preferably between 0.0325 inches and 0.0345 inches, more preferably about 0.34 inches, and most preferably 0.0335 inches.

The gap 350 may be any shape defined by a complementarily contoured first end 330 and second end 340. FIGS. 3C-3D illustrate several potential embodiments of the gap 350. In some implementations, the gap 350 may be a cut extending between the external rim 320 to the internal rim 300. In such implementations, the gap 350 may be a straight-line cut 352 as shown in FIG. 3C, a slanted-line cut 354 as shown in FIG. 3D, or a curved-line cut 356 as shown in FIG. 3E.

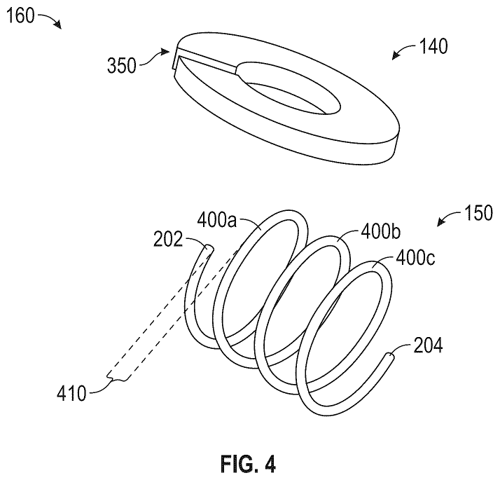

The split washer 140 may be configured such that it is adjustable between a closed position and an open position. An exemplary closed position is illustrated by FIGS. 3B and 4, whereby the upper surface 142 and the lower surface 144 are relatively parallel along plane P. In the closed position, the retaining pin 130 may not be able to pass between first end 330 and second end 340.

FIG. 3F and 3G illustrate exemplary open positions of split washer 140. In an open position, the gap 350 may be expanded such that a distance between the first end 330 and the second end 340 is greater than in the closed position. FIG. 3F illustrates a helical open position whereby the first end 330 and the second end 340 are moved vertically away from one another by a distance y. FIG. 3G illustrates a lateral open position whereby the first end 330 and the second end 340 are moved horizontally away from each other by a distance x.

In one embodiment, the open position may also be a combined open position having a distance z between the first end 330 and the second end 340 being any combination of vertical distance y and horizontal distance x. The distance y for the helical open position, the distance x for the lateral open position, and/or the distance z for the combined open position of the gap 350 may be at least a length of the diameter p.d of the retaining pin 130 or the diameter sh.d of the shaft 120, depending upon a method of installation to be used.

The split washer 140 may be made of any durable, resilient material such that the split washer may be reliably and repeatedly adjusted between closed and open positions without compromising the material's integrity. Such material may not be likely to break when being subject to the repetitive compressive forces experienced during attaching, detaching, and use of the mixer accessory In some implementations, the split washer 140 may be a metal including, but not limited to: stainless steels such as types 302, 304, 316, and 17-7 PH; nickel alloys like Inconel X-750 and Elgiloy; and copper alloys including phosphor bronze and beryllium copper. In some implementations, the split washer 140 may be made of a plastic material including, but not limited to: acetal, polycarbonate (PC), polyamide, Nylon, polypropylene, thermoplastic polyurethane (TPU), and strong fiber-reinforced plastic. In some implementations, the split washer 140 may be a metal coated with a material such as a rubber or elastomer such as natural rubber, Styrene-Butadiene Rubber, Nitrile Rubber, Neoprene, Silicone rubber, Polyurethane, thermoplastic elastomers such as SEBS, and Ethylene Propylene Diene Monomer.

The split washer 140 and spring 150 may be provided as an attachment biasing combination 160, as shown in FIG. 4. The spring 150 may further have turns 400a-n where each turn 400 may be defined as a complete 360-degree coil of the wire 200. In the spring 150 shown in FIG. 4, the spring 150 has a first turn 400a, a second turn 400b, and a third turn 400c. The spring 150 may further have a spacing 410 between the wire upper end 202 and the first turn 400a. The spacing 410 may be adjustable to be wider upon separation of the wire upper end 202 away from the first turn 400a.

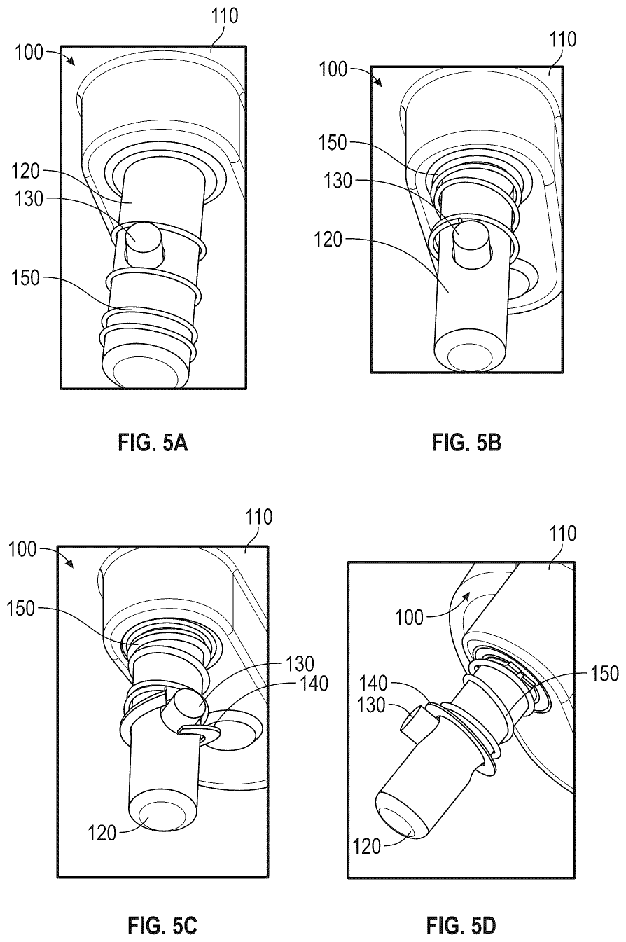

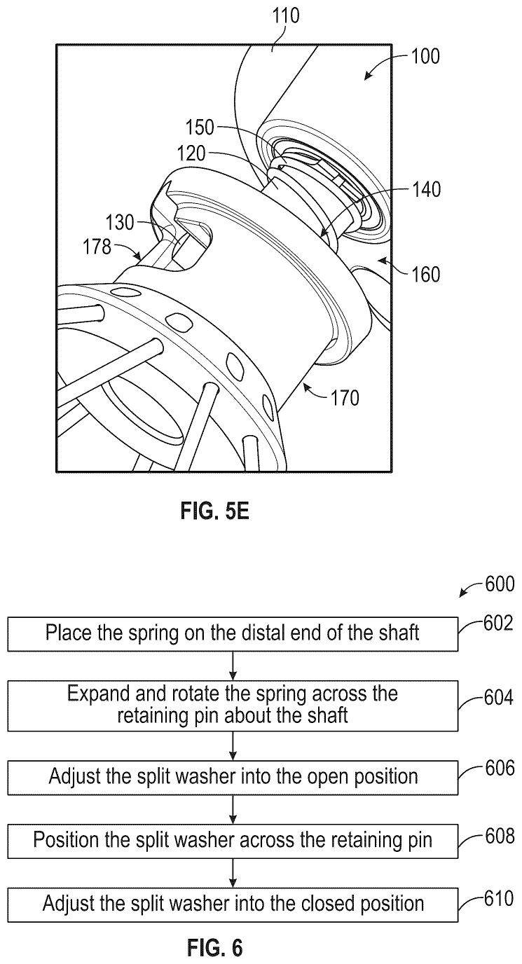

The attachment biasing combination 160 may be provided for a range of existing stand mixers 104. The attachment biasing combination 160 may be retrofitted onto existing stand mixers 104 according to an installation method 600 illustrated by FIGS. 5A-5E, shown in FIG. 6 and described in more detail below.

Referring now to FIGS. 5A-5E, in combination, shown therein are illustrations of an exemplary embodiment of the installation method 600 in accordance with the present disclosure. In FIG. 5A, the spring 150 may be placed on the distal end 124 of the shaft 120 such that the outer diameter of shaft 120 is disposed within the inner diameter of spring 150. The spring 150 may then be moved towards the proximal end 122 of shaft 120 until obstructed by the retaining pin 130. To move the spring past the retaining pin 130, the wire upper end 202 of wire 200 at the upper end 152 of spring 150 may be pulled apart from the first turn 400a such that a the spacing 410 is widened between the wire upper end 202 and the first turn 400a. The retaining pin 130 may then be placed in the gap, and the spring may be helically rotated such that the upper end 152 of spring 150 moves closer to the proximal end 122 of the shaft 120. This may proceed until the wire lower end 204 is disposed proximally of retaining pin 130, as shown in FIG. 5B.

FIG. 5C illustrates an installation of the split washer 140. In this implementation, the split washer 140 may be placed onto shaft 120 and moved near the retaining pin 130. The split washer 140 may be adjusted to the open position, such as is shown in FIGS. 3F and 3G, such that the gap 350 between the first end 330 and the second end 340 is greater than the diameter p.d of the retaining pin 130. The split washer 140 may then be moved past retaining pin 130 such that the retaining pin passes through gap 350. The split washer 140 may then be adjusted to the closed position such that it is securely held between the spring 150 and the retaining pin 130 on shaft 120, as shown in FIG. 5D.

Once the spring 150 and split washer 140 are secured above the retaining pin 130, a mixer attachment 170 may be affixed according to known methods for attaching mixer attachments 170 to a shaft 120. The hub 174 of the mixer attachment 170 may be inserted onto the shaft 120 so that the notch 184 of the hub 174 receives the retaining pin 130. The mixer attachment 170 may then be rotated such that the notch 184 and the retaining pin 130 are misaligned, and the retaining pin 130 is received within the groove 178. As shown in FIG. 5E, a mixer attachment 170 may displace the split washer 140 away from the retaining pin 130, compressing the spring 150. In turn, the spring 150 applies a restoring force to the mixer attachment 170, biasing the mixer attachment 170 towards the distal end 124 of the shaft 120 and holding the retaining pin 130 into the locked position 188 within groove 178.

FIG. 6 further shows the installation method 600 for installing the attachment biasing combination 160 onto the shaft 120 of the stand mixer 104. In a first step 602, the spring 150 may be placed onto the distal end 124 of the shaft 120. The spring 150 may then be moved along the shaft 120 towards the proximal end 122 until obstructed by the retaining pin 130.

In a second step 604, the spring 150 may be expanded and rotated across the retaining pin 130 about the shaft 120. The wire upper end 202 of wire 200 at the upper end 152 of the spring 150 may be pulled away from first turn 400a to widen the spacing 410 between the wire upper end 202 and the first turn 400a. The retaining pin 130 may then be positioned within this widened gap. Then, the spring 150 may be helically rotated around the shaft 120, effectively threading the upper end 152 over and past the retaining pin 130. This rotation may continue until the wire lower end 204 of the spring 150 is positioned proximally to the retaining pin 130, as depicted in FIG. 5B.

In a third step 606, the split washer 140 may be adjusted into the open position. Opposing forces may be applied to the first end 330 and the second end 340 of the split washer 140 to expand the gap 350 to a distance sufficient to allow the retaining pin 130 to pass through an opening defined by the gap 350.

In a fourth step 608, the split washer 140 may be positioned across the retaining pin 130. With the split washer 140 held in an open position, the split washer 140 may be carefully positioned around the shaft 120 and moved towards the retaining pin 130. Expanded gap 350 may be aligned with the retaining pin 130, allowing the split washer 140 to be rotated past the retaining pin 130.

In a fifth step 610, the split washer 140 may be adjusted back into the closed position. In some embodiments, the first end 330 and the second end 340 may move towards each other upon release of the opposing forces on the first end 330 and the second end 340 of the split washer 140, reducing a width of the gap 350. In another embodiment, complimentary forces may be applied to the first end 330 and the second end 340 of the split washer 140 such that the first end 330 and the second end 340 are moved towards one another. This action may secure the split washer 140 on the shaft 120 between lower end 154 of spring 150 (which is now positioned proximally to the retaining pin 130) and the retaining pin 130 itself, as shown in FIG. 5D. Compression of the spring 150 may now bias the split washer 140 towards the retaining pin 130.

With attachment biasing combination 160 successfully installed, the mixer attachment 170 may be affixed according to known methods for attaching the mixer attachments 170 to the shaft 120. Hub 174 of the mixer attachment 170 may be inserted onto the distal end 124 of the shaft 120, aligning the notch 184 in the hub 174 with the retaining pin 130. Once the retaining pin 130 is received within the notch 184, the mixer attachment 170 may be rotated. This rotation may misalign the notch 184 with the retaining pin 130, causing the retaining pin 130 to engage within the groove 178 of the hub 174, thereby securing the mixer attachment 170 to the shaft 120. As the hub 174 moves proximally during this attachment process, the hub 174 may contact the split washer 140, displacing the split washer 140 further away from the retaining pin 130 and further compressing the spring 150. Compressed spring 150 may then exert a distally-directed restoring force on the hub 174 through the split washer 140, effectively biasing the mixer attachment 170 towards the distal end 124 of the shaft 120 and ensuring the retaining pin 130 is held firmly within the locked position 188 of the groove 178, as illustrated in FIG. 5E

### CONCLUSION

The problem of stand mixer attachment wear caused by attachment movement along the shaft is addressed by the mixer attachment biasing combination comprising a spring and split washer disclosed herein. While prior-art attempts to address this problem have required a degree of disassembly of the stand mixer, the mixer attachment biasing combination disclosed herein may be installed onto a stand mixer shaft without requiring any disassembly of the stand mixer.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

What is claimed is:

1. A stand mixer assembly, comprising:
a motor housing;
a motor disposed in the motor housing;
a shaft operably connected to the motor so the shaft is rotatable and having a portion extending from the motor housing;
a retaining pin extending laterally from the shaft;
a compression spring having an upper end and a lower end, the compression spring disposed about the shaft and positioned between the motor housing and the retaining pin; and
a split washer positioned about the shaft between the lower end of the compression spring and the retaining pin so the compression spring biases the split washer toward the retaining pin,
wherein the split washer has an external rim and an opening defined by an internal rim, the split washer has a gap defined by a first end and a second end of the split washer, so the first end and the second end of the split washer are axially movable relative to one another.

2. The stand mixer assembly of claim 1, wherein the compression spring and split washer comprise stainless steel.

3. The stand mixer assembly of claim 1, wherein the gap is a straight-line cut from the external rim to the internal rim.

4. The stand mixer assembly of claim 1, wherein the gap is a curved-line cut from the external rim to the internal rim.

5. The stand mixer assembly of claim 1, wherein the gap has a width of about 0.01 inches.

6. The stand mixer assembly of claim 1, wherein the split washer has a thickness of about 0.034 inches.

7. The stand mixer assembly of claim 1, wherein the split washer has an inner diameter of about 0.5 inches and an outer diameter of about 0.75 inches.

8. A method for securing a mixer attachment having a hub with a notch to a shaft of a standing mixer extending from a motor housing, the shaft having a retaining pin with a diameter and extending laterally from the shaft, the method comprising:
obtaining a compression spring having an upper end and a lower end;
positioning the compression spring on the shaft and threading the compression spring past the retaining pin so the compression spring is positioned between the motor housing and the retaining pin;
providing a split washer having an external rim and an opening defined by an internal rim, the split washer having a gap defined by a first end and a second end of the split washer, the split washer being resilient in a way that the first end and the second end are axially movable relative to one another;
axially moving the first end of the split washer and the second end of the split washer away from one another so that the first end and the second end are spaced a distance equal to at least the diameter of the retaining pin;
sliding the split washer along the shaft past the retaining pin so the split washer is positioned between the lower end of the compression spring and the retaining pin and the compression spring biases the split washer toward the retaining pin;
inserting the hub of the mixer attachment onto the shaft so the notch receives the retaining pin and the split washer circumferentially engages the hub; and
rotating the mixer attachment to misalign the retaining pin and the notch so the mixer attachment is connected to the shaft and the split washer biases the hub of the mixer attachment against the retaining pin.

9. The method of claim 8, wherein the step of wherein obtaining the compression spring further comprises obtaining the compression spring having the upper end and the lower end, the compression spring constructed of stainless steel.

10. The method of claim 8, wherein the step of providing a split washer further comprises providing the split washer having the external rim and the opening defined by the internal rim, the split washer having the gap defined by the first end and the second end of the split washer, the split washer being resilient in a way that the first end and the second end are axially movable relative to one another, the split washer constructed of stainless steel.

11. The method of claim 8, wherein the step of providing a split washer further comprises providing the split washer having the external rim and the opening defined by the internal rim, the split washer having the gap defined by the first end and the second end of the split washer, the split washer being resilient in a way that the first end and the second end are axially movable relative to one another, the gap being a straight-line cut from the external rim to the internal rim.

12. The method of claim 8, wherein the step of providing a split washer further comprises providing the split washer having the external rim and the opening defined by the internal rim, the split washer having the gap defined by the first end and the second end of the split washer, the split washer being resilient in a way that the first end and the second end are axially movable relative to one another, the gap being a curved-line cut from the external rim to the internal rim.

13. The method of claim 8, wherein the step of providing a split washer further comprises providing the split washer having the external rim and the opening defined by the internal rim, the split washer having the gap defined by the first end and the second end of the split washer, the split washer being resilient in a way that the first end and the second end are axially movable relative to one another, the gap having a width of about 0.01 inches.

14. The method of claim 8, wherein the step of providing a split washer further comprises providing the split washer having the external rim and the opening defined by the internal rim, the split washer having the gap defined by the first end and the second end of the split washer, the split washer being resilient in a way that the first end and the second end are axially movable relative to one another, the split washer having a thickness of about 0.034 inches.

15. The method of claim 8, wherein the step of providing a split washer further comprises providing the split washer having the external rim and the opening defined by the internal rim, the split washer having the gap defined by the first end and the second end of the split washer, the split washer being resilient in a way that the first end and the second end are axially movable relative to one another, the split washer having an inner diameter of about 0.5 inches and an outer diameter of about 0.75 inches.
